(19) United States
(12) Patent Application Publication
(10) Pub. No.: US 2014/0108000 A1
(43) Pub. Date: Apr. 17, 2014

(54) Generate, Edit, and Automated Use of a Machine-Readable Cable Specification to Audit Cabling of a Converged Infrastructure

(71) Applicant: Cisco Technology, Inc., San Jose, CA (US)

(72) Inventors: Raju Datla, Pleasanton, CA (US); Raju S V L N Penmetsa, San Jose, CA (US); Bhaskar Krishnamsetty, Flower Mound, TX (US); Parthasarathy Venkatavaradhan, Sunnyvale, CA (US); Srinivas Velpuri, Dublin, CA (US)

(73) Assignee: Cisco Technology, Inc., San Jose, CA (US)

(21) Appl. No.: 14/035,372

(22) Filed: Sep. 24, 2013

Related U.S. Application Data
(60) Provisional application No. 61/712,555, filed on Oct. 11, 2012.

(51) Int. Cl. G06F 17/50

(52) U.S. Cl. CPC G06F 17/5009
USPC 703/21

(57) ABSTRACT

A human-readable cable specification for a model converged infrastructure (CI) is converted to a machine-readable cable specification specifying model port mappings between model components of the model CI. The machine-readable cable specification is imported into a controller, which is in communication with an actual CI that includes operating components and actual connections between input/output (I/O) signal ports of the components. Port configurations are collected from the operating components, and actual port mappings are generated that identify the connections between the actual ports. The actual port mappings are compared against the model port mappings. A compliance report is generated indicating port mapping mismatches, if any, between the model and actual port mappings based on the comparing.

### CROSS-REFERENCE TO RELATED APPLICATION

This application claims the benefit of U.S. Provisional Application No. 61/712,555, filed Oct. 11, 2012, which is hereby incorporated by reference in its entirety.

### TECHNICAL FIELD

The present disclosure relates to automated cable compliance checking of converged infrastructures.

### BACKGROUND

A data center, cloud resource, or the like, may be implemented in the form of a converged infrastructure (CI). The CI is a set of integrated Information Technology (IT) components or devices, such as storage, network, compute, and virtualization components. Connecting the different components together with cables, i.e., cabling the components, correctly and consistently is essential for the CI to operate correctly. A CI vendor typically provides a blueprint to specify a standardized design or model CI. The blueprint includes a cable specification to identify cable connections between components in the model CI. After a service integrator (i.e., user) has interconnected the actual components of a deployed CI according to such a cable specification, there is no convenient, automated way for the user to ensure that the actual connections in the deployed CI are in compliance with the cable specification for the model CI. Moreover, users often find such a cable specification to be highly restrictive because of its strictly defined input/output (I/O) port mappings. Currently, there is no way for the user to customize a given cable specification to suit local cabling requirements or needs.

### BRIEF DESCRIPTION OF THE DRAWINGS

FIG. 1 is a block diagram of an example converged infrastructure environment in which a converged infrastructure (CI) is configured by and operates under control of a CI controller.

FIG. 2 is a block diagram of an example CI controller configured to perform operations to implement techniques provided herein as related to the CI from FIG. 1.

FIG. 3A and 3B collectively represent a flowchart of example operations to (i) generate a machine-readable cable specification from a human-readable blueprint cable specification (FIG. 3A), (ii) optionally edit the machine-readable specification (FIG. 3B), and (iii) use the machine-readable specification for compliance checks/audits of an actual, operating CI (FIG. 3B).

FIG. 4 is a flowchart expanding on a selectively enabling editing operation of the method of FIGS. 3A and 3B.

FIG. 5 is an illustration of an example FlexPod™ architecture taken from a human-readable blueprint for the FlexPod.

FIG. 6 is an excerpt of specific human-readable model input/output (I/O) port mappings taken from a blueprint cable specification for the FlexPod.

FIG. 7 is an illustration of example machine-readable I/O port mappings.

FIG. 8 is an illustration of an example format of actual port mappings generated in the method of FIGS. 3A and 3B.

FIG. 9 is an illustration of an example display to present results of a comparison operation in the method of FIGS. 3A and 3B.

FIGS. 10A and 10B are respective illustrations of (i) an example menu to prompt a user to select whether to edit model I/O port mappings, and (ii) an example model FlexPod™ I/O port mapping displayed as a result of its selection from the menu of FIG. 10A.

### DESCRIPTION OF EXAMPLE EMBODIMENTS

### Overview

A technique to generate, edit, and use a machine-readable cable specification to audit cabling of an operating converged infrastructure is provided herein. The technique includes importing into a computing apparatus a machine-readable cable specification for a model converged infrastructure including model compute, storage, and network components. Each of the model components includes model ports to receive and send signals, and the cable specification includes machine-readable model port mappings that specify model connections between the model ports. The technique includes interfacing with an actual converged infrastructure that includes operating compute, storage, and network components and connections between ports of the components. The technique also includes collecting from each of the operating compute, storage, and network components respective port configurations indicative of the connections between the component ports, and generating actual port mappings that identify the connections between the component ports based on the collected port configurations. The technique also includes comparing the actual port mappings against the model port mappings, and generating a compliance report indicating port mapping mismatches, if any, between the model and actual port mappings based on the comparing.

### Example Embodiments

A converged infrastructure (CI) is a modular, integrated, often pre-configured or at least easily configured, set of information technology (IT) components, typically including storage, network, compute, and virtualization components, that may be shared across multiple user applications that require storage, network, and compute resources. Due to the modular nature of the CI, the CI components made available to the user applications may be scaled up and down relatively easily and efficiently in order to accommodate corresponding increases and decreases in user application resource requirements. Examples of known converged infrastructures (CIs) include, but are not limited to, FlexPod™ by NetApp and Cisco, VSPEX by EMC, and Vblock™ by VCE. Such known CIs are configured and operated in accordance with respective vendor CI specifications referred to herein as “blueprints” that have become quasi-industry standards.

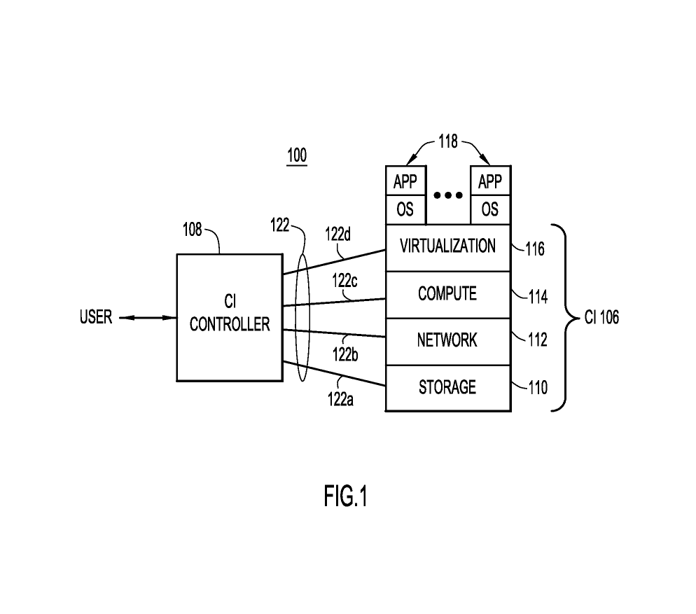

Referring first to FIG. 1, a block diagram of an example (CI) environment 100 is shown in which a CI 106 is configured by and operates under control of, a CI Controller 108. CI 106 includes an integrated set of components, including a storage component 110 to provide data storage, a network component 112 to provide connectivity to external devices and communication networks, a compute or server component 114 to provide processing capacity to the CI, and a virtualization component 116, such as a hypervisor, to host virtual environments. Virtualization component 116 may host multiple virtual user operating environments 118 on the stack of CI components 110, 112, and 114. Virtual user operating environments 118 may each include a virtualized operating system (OS), and one or more applications (APs) executing in the virtualized OS. Components 110, 112, and 114 provide respective data storage, network, and compute resources required by each OS and the respective one or more APs. From a mechanical perspective, each of components 110-114 is typically housed in one or more rack-and-stack chassis. Each component chassis includes multiple input/output (I/O) signal ports, typically mounted on a back panel of the chassis, that communicate with, i.e., transmit signals to and/or receive signals from, I/O ports of the same component and/or I/O ports of other components over electrical cables connected between the communicating I/O ports. The terms “I/O port(s)” and “I/O signal port(s)” are also referred to herein simply as “port(s).”

At a high-level, CI Controller 108 serves as a unified, automated, resource configured to manage CI 106. CI Controller 108 includes one or more Graphical User Interfaces (GUIs) through which a user may issue commands and provide data to the CI Controller to selectively cause the controller to perform operations with respect to CI 106, such as to provision, configure, assess/validate, and monitor the CI. CI Controller 108 manages CI 106 over a bi-directional communication interface 122, including component interfaces 122a, 122b, 122c, and 122d each to communicate directly with a respective one of storage, network, compute, and virtualization components 110, 112, 114, and 116. Component interfaces 122a-122d may support communications in accordance with any number of different protocols, including, for example, a network protocol such as the HyperText Transfer Protocol (HTTP), Telnet, or Simple Network Management Protocol (SNMP). To the extent that components 110-116 of CI 106 support different interface protocols, such as a Rich Text or Extensible Markup Language (XML), component interfaces 122a-122d of CI Controller 108 correspondingly support the different protocols, and the CI Controller may be configured to communicate with components 110-116 using different protocols to maintain interface compatibility with the components as necessary.

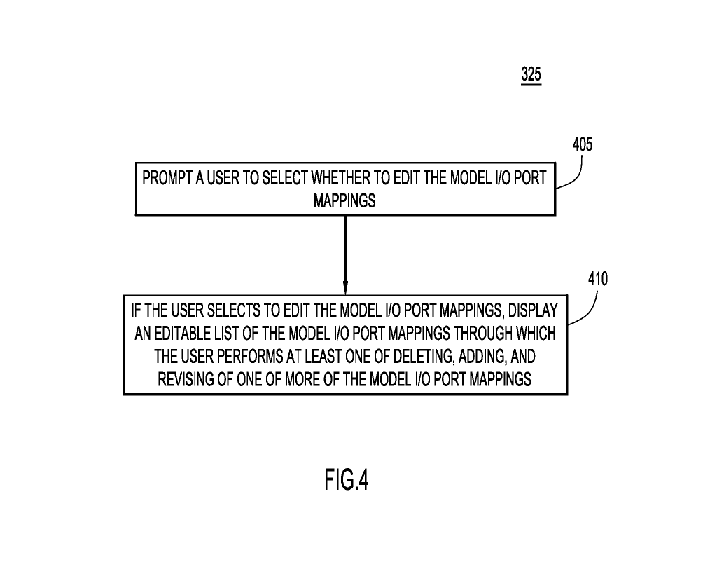

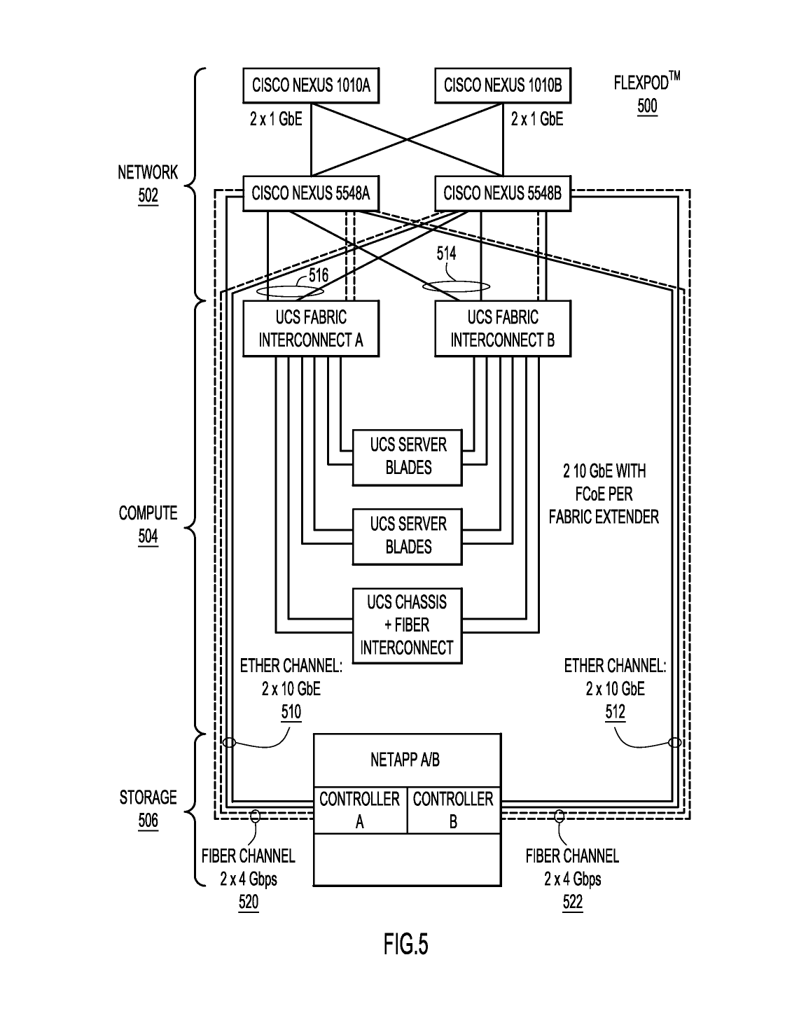

As mentioned above, a specific design of CI 106 may be in accordance with a vendor blueprint. Because the blueprint complies with vendor specifications, the blueprint is said to represent or define a “validated” design or model (i.e., data model) of a CI. In one form, the blueprint is a human-readable text- and graphics-based document that defines to a user many manual step-by-step procedures, a cable specification, and related information required to configure and deploy each of the CI components of an actual, operating CI in accordance with the specific design. The blueprint cable specification specifies cable connections between ports of the storage, network, and compute components of the model CI. If a user wishes to configure and deploy an actual CI, e.g., CI 106, in accordance with the blueprint cable specification, the user interconnects respective ports of storage, network, and compute components 110-116 of the CI according to the cable specification. Excerpts of a cable specification from a blueprint for FlexPod™ are depicted in, and will be described below in connection with, FIGS. 5 and 6.

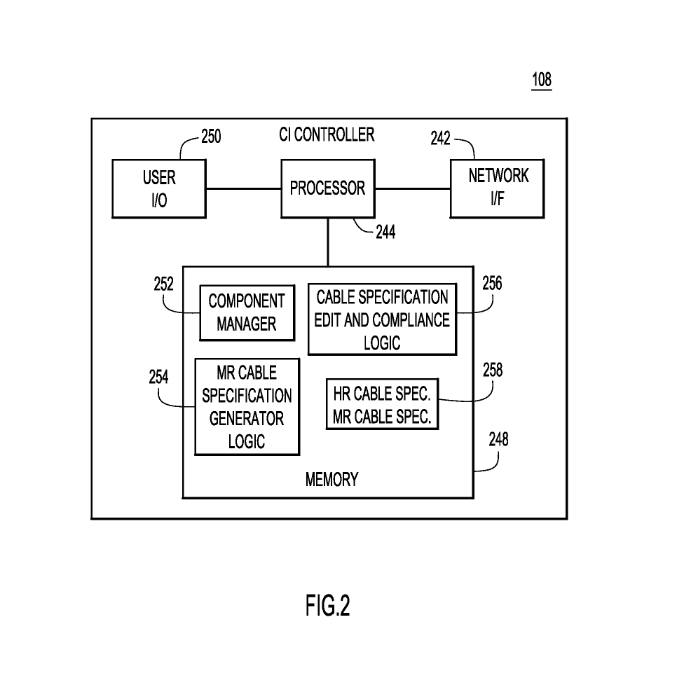

The techniques presented herein advantageously perform automated cable compliance checking, i.e., cable auditing, of an actual, operating CI (e.g., CI 106) against a blueprint cable specification, and also permit the cable specification to be customized/edited prior to and/or after the cable auditing. In brief, in an a priori or offline phase, a user generates a machine-readable cable specification from a human-readable blueprint cable specification. Then, in an operational phase, CI controller 108 imports the machine-readable cable specification, enables a user to edit the imported specification if desired, and uses the imported specification to perform automated cable compliance checks/audits on an operating CI (e.g., CI 106) while the CI is connected to the CI controller. The techniques presented herein are now described more fully with reference to FIGS. 2-9.

With reference to FIG. 2, there is shown an example block diagram of CI Controller 108 configured to perform operations described herein. There are numerous possible configurations for CI Controller 108 and FIG. 2 is meant to be an example. CI Controller 108 includes a network interface unit 242, a processor 244, memory 248, and a user Input/Output module 250 used in association with the one or more GUIs to enable the user to interface with the CI Controller. The network interface (I/F) unit 242 is, for example, an Ethernet card device that allows the CI Controller 108 to communicate over a network, e.g., a wired (Ethernet) network. Network I/F 242 may also include wireless connection capability. Interface 122 (from FIG. 1) may be implemented through network I/F unit 242. The processor 244 is a microcontroller or microprocessor, for example, configured to execute software instructions stored in the memory 248.

The memory 248 may comprise read only memory (ROM), random access memory (RAM), magnetic disk storage media devices, optical storage media devices, flash memory devices, electrical, optical, or other physical/tangible (e.g., non-transitory) memory storage devices. Thus, in general, the memory 248 may comprise one or more computer readable storage media (e.g., a memory device) encoded with software comprising computer executable instructions and when the software is executed (by the processor 244) it is operable to perform the operations described herein. For example, the memory 248 stores or is encoded with instructions for Component Manager Logic 252 to perform generalized management operations on CI 106, Machine-Readable (MR) Cable Specification Generator logic 254 to assist a user in generating a machine-readable cable specification from a human-readable blueprint cable specification, and Cable Specification Edit and Compliance logic 256 to use the machine-readable c able specification to allow a user to edit the machine-readable cable specification if desired, and use the machine-readable cable specification to perform automated cable compliance checks on an actual, operating CI. In addition, the memory 248 includes a memory portion 258 to store one or more human-readable (HR) blueprint cable specifications and one or more corresponding machine-readable cable specifications. The memory GUI logic may be divided among logic units 252, 254, and 256 as necessary to support the respective logic operations.

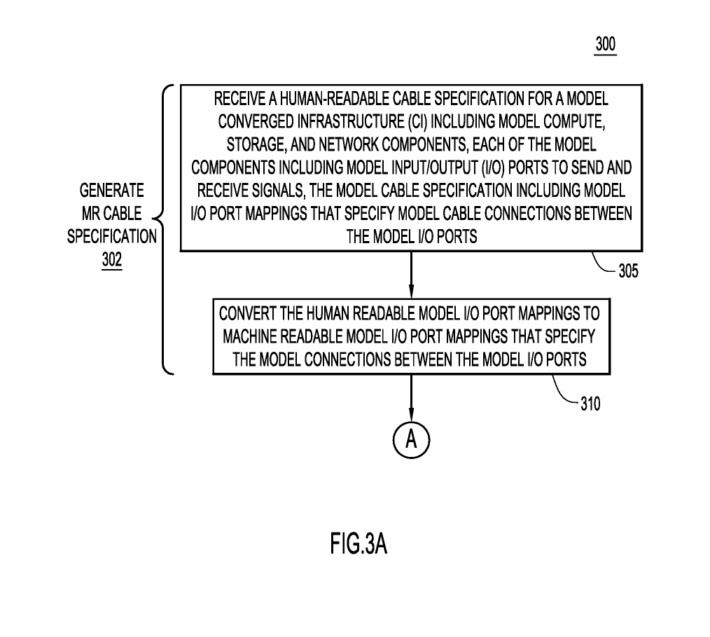

With reference to FIGS. 3A and 3B, there is depicted a flowchart of an example method 300 including high-level a priori operation 302 (FIG. 3A) to generate a machine-readable cable specification from a human-readable blueprint cable specification, and run-time operation 304 (FIG. 3B) to edit the machine-readable specification (if desired) and use it for compliance checks/audits.

High-level operation 302, which includes operations 305 and 310, is described first. High-level operation 302 may be performed by a user with access to a computer, which may or may not be CI controller 108, and with the assistance of Machine-Readable Cable Specification Generator logic 254.

At 305, the user receives/accesses a human-readable blueprint cable specification for a model CI including model compute, storage, and network components. Each of the model components includes model input/output (I/O) ports to send and/or receive (model) signals. The model cable specification includes model port mappings that specify model cable connections between the model ports.

At 310, the user converts/translates the human-readable model port mappings to machine-readable model port mappings that specify the model connections between the model ports. The user enters the machine-readable model port mappings into the computer, which may be CI controller 108. The term “machine-readable” means that constituent elements of the machine-readable port mappings may be interpreted by and operated on, e.g., compared against each other, by a computer. The machine-readable model port mappings may be generated in any number of different formats including, but not limited to, Extensible Mark-up Language (XML), JSON, and so on.

After the machine-readable model port mappings have been generated, high-level operation 304, including operations 315-350, is performed by Cable Specification Edit and Compliance logic 256.

At 315, logic 256 imports the machine-readable cable specification, including the machine-readable model port mappings.

At 320, CI controller 108 (and logic 256) interfaces with an actual, operating CI, i.e., with CI 106 while components 110-114 are operating. It is assumed that actual ports of components 110-114 of CI 106 have been interconnected with cables in accordance with the port mapping specified in the human-readable blueprint cable specification, at least in part, although this is not necessary.

At 325, logic 256 optionally selectively enables editing (i.e., customizing) of the imported machine-readable model port mappings, and if the editing is enabled, logic 256 accepts edits to the machine-readable model port mappings. Therefore, at 325, the user may optionally customize the machine-readable model port mappings.

At 330, logic 256 collects from each of operating components 110-114 respective port configurations indicative of the actual connections between the ports of the components. The port configurations collected at 330 are referred to as “adjacency data.” To collect this information, logic 256 sends machine-level commands to components 110-114 over interfaces 122a-122c to request port status from the components, and receives the requested port status from the components over the interfaces. The received status identifies which ports are connected to which ports. That is, the received status indicates the end points of each cable in the actual CI. The machine-level commands and the received port status may be formatted in XML, for example.

At 335, logic 256 generates actual port mappings that identify the actual connections between the ports of operating components 110-116 based on the port configurations collected at 330. The actual port mappings are also formatted in a machine-readable language, such as, e.g., XML.

At 340, logic 256 compares the machine-readable actual port mappings against the machine-readable model port mappings. For example, XML formatted actual port mappings are compared against XML formatted machine-readable model port mappings (that were generated at operation 310).

At 345, logic 256 generates a compliance report indicating port mapping mismatches, if any, between the machine-readable model and actual port mappings based on results of the compare at 340.

At 350, if the compare (and thus generate compliance report) operation indicate any mismatches between the machine-readable model and actual port mappings, logic 350 repeats the following operations under user control: selectively enable editing and accept editing 325, collect port configurations 330, generate actual port mappings 335, compare 340, and generate a compliance report 345.

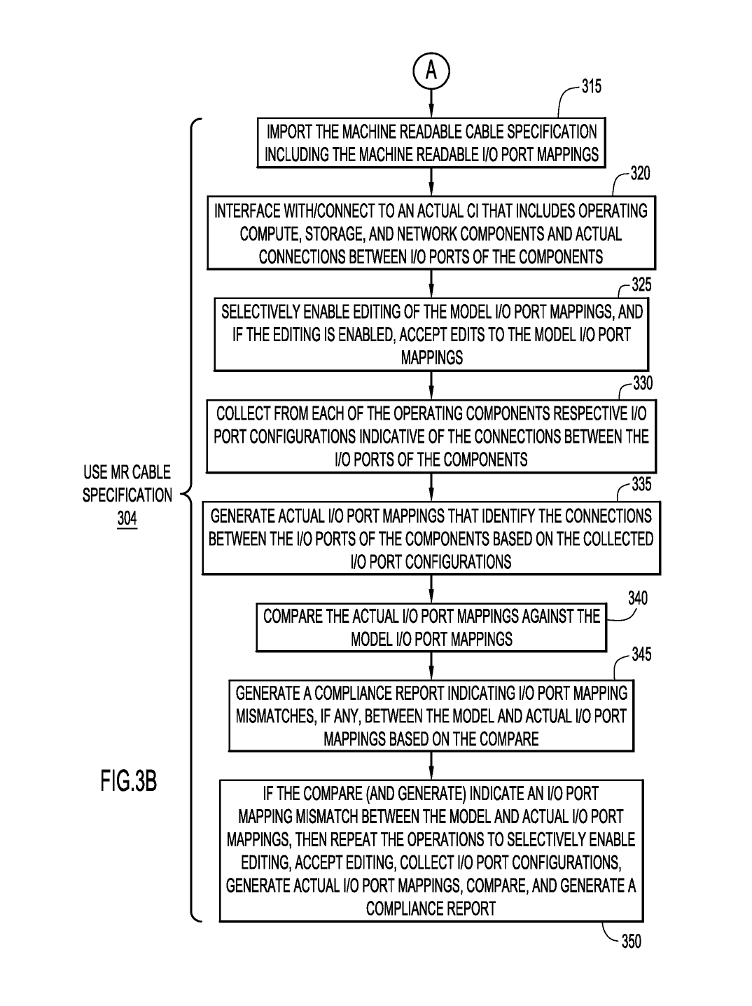

With reference to FIG. 4, a flowchart expanding on selectively enable editing operation 325 is depicted.

At 405, logic 256 displays a menu to prompt a user to select whether to edit the machine-readable model port mappings.

At 410, if the user selects to edit the machine-readable model port mappings from the menu, then logic 256 displays an editable list of the machine-readable model port mappings through which the user performs at least one of the deleting, adding, and revising of one of more machined readable model port mappings.

As described above, operations 305 and 310 convert the model port mappings of a human-readable blueprint cable specification into machine-readable port mappings. An excerpt of a human-readable cable specification from a blueprint for an example FlexPod™ CI system is depicted in FIG. 5. More specifically, with reference to FIG. 5, there is an illustration of a FlexPod architecture 500 including rack-and-stack FlexPod components showing high-level cable connections between the components. A network component 502 of the FlexPod includes the following units/devices: Cisco Nexus 1010A & B and 5548A & B switch units. A compute component 504 includes the following devices: Cisco Unified Computing System (UCS) 6120 and 2140 Fabric Interconnects; a UCS 5108 Chassis; and UCS B200s and B250s server blades. A storage component 506 includes NetApp A & B units, including controllers A & B. In FIG. 5, Giga-bit Ethernet (GbE) cable connections between network, compute, and storage units 502-506 are depicted in solid line, e.g., at 510, 512, 514, and 516, although other connections are shown that are not specifically identified with a reference numeral. Also, Fibre-Channel cable connections (e.g., 4 Giga-bit-per-second (Gbps) connections) between network component 502 and storage component 506 are depicted in dotted line, e.g., at 520 and 522, although other connections are shown that are not specifically identified with a reference numeral.

With reference to FIG. 6, there is depicted an excerpt of a table listing specific human-readable model port mappings 600 for the FlexPod architecture 500 shown in FIG. 5, also taken from the Flexpod blueprint. Model port mappings 600 list connections or links 603, 604, 605, and so on, between pairs of ports, where each pair of ports includes a local port on one of components 502-506 and a remote port on one of components 502-506. For example, link 603 represents a cable connected between a local port (identified as Eth1/1 on Cisco Nexus 5548A of network component 502) and a remote port (identified as e2a on NetApp Controller A of storage component 506). If the local and remote ports are on the same one of components 502-506, the link is referred to as an intra-component link. If the local and remote ports are on different ones of components 502-506, the link is referred to as an inter-component link. The “local” port originates a signal and the “remote” port receives the signal.

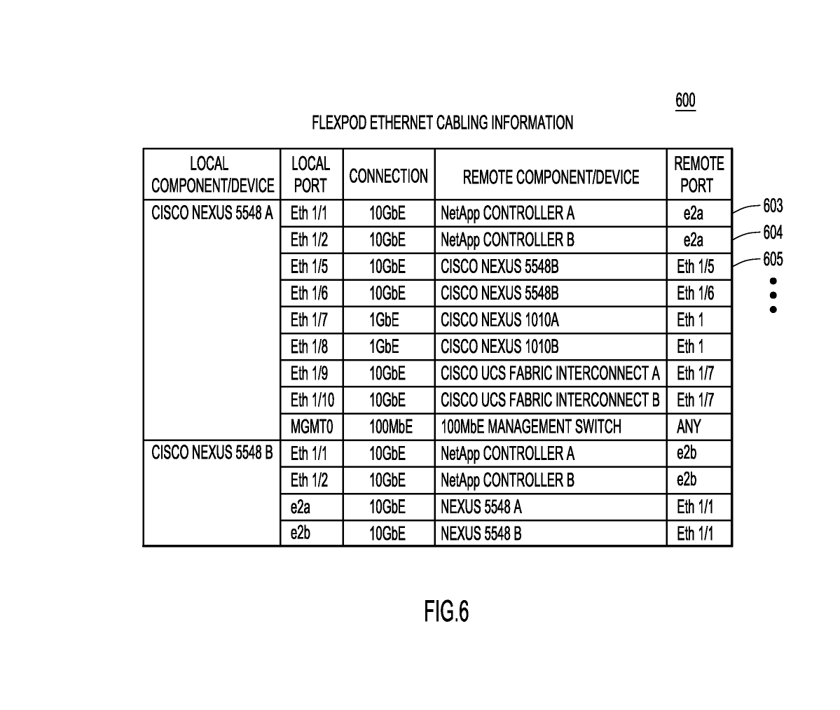

As described above in connection with FIG. 3A at operation 310, human-readable model port mappings, e.g., port mappings 600, are converted into machine-readable port mappings. With reference to FIG. 7, example machine-readable model port mappings 700 are depicted (and entitled “Link Specification (I/O Port Mappings).” Machine-readable model port mappings 700 includes a list of links, one of which is depicted as a “Link (Port Mapping)” 702. Link 702 specifies a cable/link connection between end points, including (i) an originating or local port 704 identified by a “Local Network Element Identifier” and a “Local Network Port Identifier,” and (ii) a receiving or remote port 706 identified by a “Remote Network Element Identifier” and a “Remote Network Port Identifier.” Each aforementioned “Identifier” is a unique string identifying a network element (e.g., unit of a CI component, as depicted in FIG. 5).

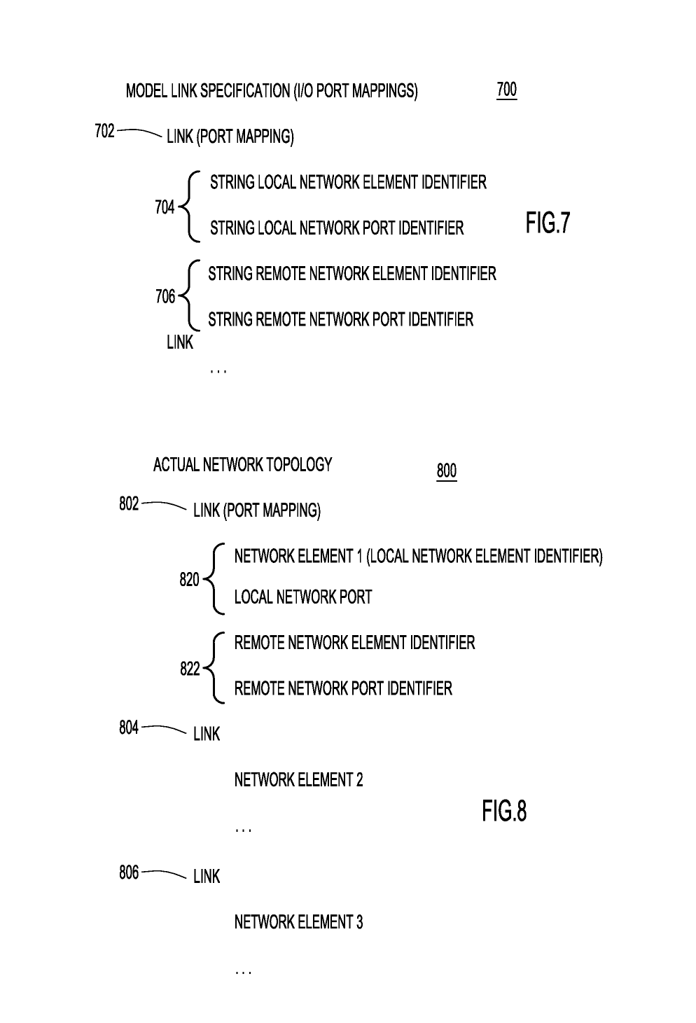

As is also described above in connection with FIG. 3B, operation 330 collects information (i.e., port configurations) from operating components 110-114 of CI 106 indicative of actual connections between the actual ports of the components, and then operation 335 generates actual port mappings based on the collected information. With reference to FIG. 8, an example format of actual port mappings 800 is depicted. Actual port mappings 800 include multiple actual links 802, 804, 806, and so on, generated at operation 335. Collectively, links 802-806 represent a “network topology,” also referred to as a cable topology, of operating CI 106. Actual links 802-806 are formatted in a manner that is consistent with the way in which the human-readable and machine-readable links depicted in FIGS. 6 and 7 are formatted, respectively. For example, link 802 specifies an actual link (port mapping) between (i) a local port 820 identified as “Network Element 1”—the “Local Network Element Identifier”—and a “Local Network Port Identifier,” and (ii) a remote port 822 identified by a “Remote Network Element Identifier” and a “Remote Network Port Identifier.”

As is also described above in connection with FIG. 3B, operation 340 compares actual port mappings against machine-readable model port mappings. In an example, elements 704, 706 of link 702 (a machine-readable port mapping generated from the human-readable blueprint) may be compared against elements 820, 822 of link 802 (an actual port mapping collected from operating CI components).

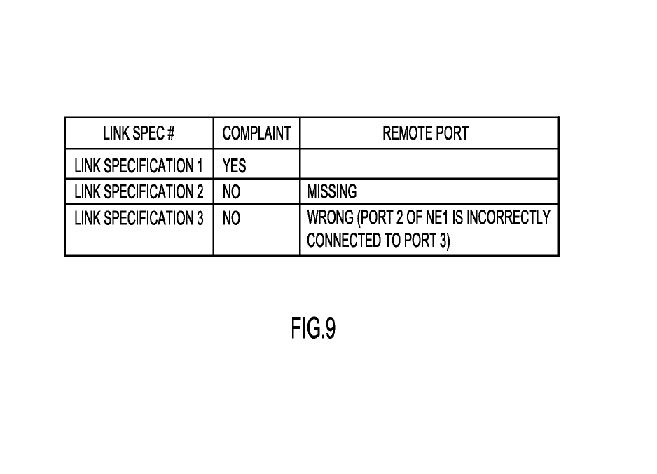

Results of compare operation 340, including detected mismatches between the machine-readable model port mappings and the actual port mappings, are displayed to the user. With reference to FIG. 9, there is an illustration of an exemplary display 900 of compare results. Display 900 results from a compare of machine-readable model port mappings against actual port mappings 800 of FIG. 8, for example.

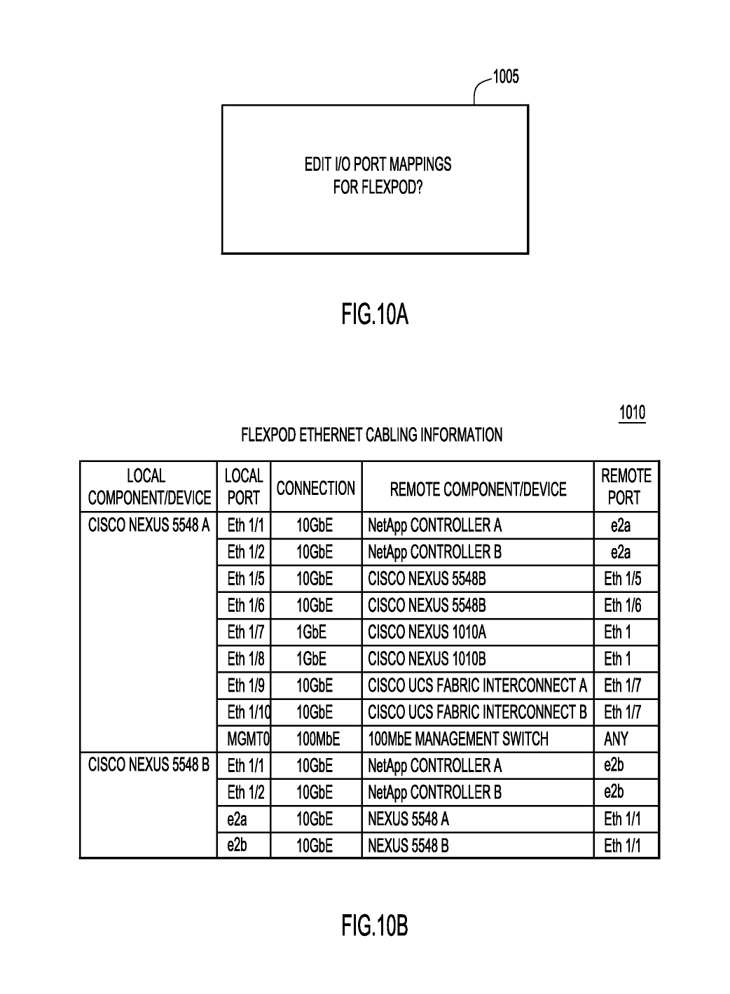

As described above in connection with FIG. 4, editing operations 405 and 410 prompt a user to select whether to edit model I/O port mappings and then, if the user selects to edit, display the selected I/O port mappings for editing. With reference to FIG. 10A, there is shown an illustration of an example menu 1005 to prompt a user to select whether to edit model I/O port mappings for FlexPod™. With reference to FIG. 10B, there is shown an illustration of example FlexPod™ I/O port mappings 1010 available for editing as a result of a selection to from menu 905.

As described herein, a technique is provided to generate, edit, and use a machine-readable model cable specification to audit the actual cabling of an operating CI. The machine-readable model cable specification is accessed and manipulated in a computer connected with the operating CI and may be customized easily by a user/operator of the computer. In an automated manner, the computer collects actual I/O port cable connection information from the operating CI over a communication interface, generates actual port mappings from the collected information, and compares the actual port mappings against the machine-readable model cable specification. The computer displays results of the compare and automatically flags to the user mismatches between the actual and machine-readable model cable specification.

In summary, in one form, a method is provided, comprising: importing into a computing apparatus a machine-readable cable specification for a model converged infrastructure including model compute, storage, and network components, each of the model components including model ports to receive and send signals, the cable specification including machine-readable model port mappings that specify model connections between the model ports; and, with the computing apparatus: interfacing with an actual converged infrastructure that includes operating compute, storage, and network components and connections between ports of the components; collecting from each of the operating compute, storage, and network components respective port configurations indicative of the connections between the component ports; generating actual port mappings that identify the connections between the component ports based on the collected port configurations; comparing the actual port mappings against the model port mappings; and generating a compliance report indicating port mapping mismatches, if any, between the model and actual port mappings based on the comparing.

In another form, an apparatus is provided, comprising: a network interface unit configured to send and receive communications over a network; and a processor coupled to the network interface unit, and configured to: import a machine-readable cable specification for a model converged infrastructure including model compute, storage, and network components, each of the model components including model ports to receive and send signals, the cable specification including machine-readable model port mappings that specify model connections between the model ports; interface with an actual converged infrastructure that includes operating compute, storage, and network components and connections between ports of the components; collect from each of the operating compute, storage, and network components respective port configurations indicative of the connections between the ports of the components; generate actual port mappings that identify the connections between the ports of the components based on the collected port configurations; compare the actual port mappings against the model port mappings; and generate a compliance report indicating port mapping mismatches, if any, between the model and actual port mappings based on the comparing.

In still another form, a processor readable medium is provided for storing instructions that, when executed by a processor, cause the processor to: import a machine-readable cable specification for a model converged infrastructure including model compute, storage, and network components, each of the model components including model ports to receive and send signals, the cable specification including machine-readable model port mappings that specify model connections between the model ports; interface with an actual converged infrastructure that includes operating compute, storage, and network components and connections between ports of the components; collect from each of the operating compute, storage, and network components respective port configurations indicative of the connections between the ports of the components; generate actual port mappings that identify the connections between the ports of the components based on the collected port configurations; compare the actual port mappings against the model port mappings; and generate a compliance report indicating port mapping mismatches, if any, between the model and actual port mappings based on the comparing.

Although the apparatus, system, and method are illustrated and described herein as embodied in one or more specific examples, it is nevertheless not intended to be limited to the details shown, since various modifications and structural changes may be made therein without departing from the scope of the apparatus, system, and method and within the scope and range of equivalents of the claims. Accordingly, it is appropriate that the appended claims be construed broadly and in a manner consistent with the scope of the apparatus, system, and method, as set forth in the following claims.

1. A method comprising:
importing into a computing apparatus a machine-readable cable specification for a model converged infrastructure including model compute, storage, and network components, each of the model components including model ports to receive and send signals, the cable specification including machine-readable model port mappings that specify model connections between the model ports; and, with the computing apparatus:
interfacing with an actual converged infrastructure that includes operating compute, storage, and network components and connections between ports of the components;
collecting from each of the operating compute, storage, and network components respective port configurations indicative of the connections between the component ports;
generating actual port mappings that identify the connections between the component ports based on the collected port configurations;
comparing the actual port mappings against the model port mappings; and
generating a compliance report indicating port mapping mismatches, if any, between the model and actual port mappings based on the comparing.

2. The method of claim 1, further comprising, prior to the comparing:
selectively enabling editing of the model port mappings; and
if the editing is enabled, accepting editing of the machined readable model port mappings, including at least one of deleting, adding, and revising one or more of the machine-readable port mappings.

3. The method of claim 2, further comprising:
if the comparing indicates a port mapping mismatch between the model and actual port mappings, then repeating the selectively enabling and accepting editing, the collecting port configurations, the generating actual port mappings, the comparing, and the generating a compliance report.

4. The method of claim 2, wherein the selectively enabling editing includes:
prompting a user to select whether to edit the model port mappings; and
if the user selects to edit the model port mappings, displaying an editable list of the model port mappings through which the user performs the at least one of the deleting, adding, and revising of the one of more model port mappings.

5. The method of claim 1, wherein the generating a compliance report includes displaying the mismatches, if any, between the model and actual port mappings.

6. The method of claim 1, wherein:
the importing includes importing model port mappings that specify connections between model ports on a given model component and model port mappings that specify connections between model ports on different model components; and
the generating actual port mapping includes generating actual port mappings that identify connections between ports on a given operating component and actual port mappings that specify connections between ports on different operating components.

7. The method of claim 1, wherein:
the importing includes importing the model port mappings as a first Extensible Markup Language (XML) document;
the generating actual port mappings includes generating the actual port mappings as a second XML document; and
the comparing includes comparing the first and second XML documents against each other.

8. The method of claim 1, further comprising, prior to the importing:
receiving a human-readable cable specification for the model converged infrastructure, the human-readable cable specification including model port mappings in human-readable form; and
converting the human-readable model port mappings to the machine-readable model port mappings.

9. An apparatus comprising:
a network interface unit configured to send and receive communications over a network; and
a processor coupled to the network interface unit, and configured to:
import a machine-readable cable specification for a model converged infrastructure including model compute, storage, and network components, each of the model components including model ports to receive and send signals, the cable specification including machine-readable model port mappings that specify model connections between the model ports;
interface with an actual converged infrastructure that includes operating compute, storage, and network components and connections between ports of the components;
collect from each of the operating compute, storage, and network components respective port configurations indicative of the connections between the ports of the components;
generate actual port mappings that identify the connections between the ports of the components based on the collected port configurations;
compare the actual port mappings against the model port mappings; and
generate a compliance report indicating port mapping mismatches, if any, between the model and actual port mappings based on the comparing.

10. The apparatus of claim 9, wherein the processor is further configured to:
selectively enable editing of the model port mappings; and
if the editing is enabled, accept editing of the machined readable model port mappings, including at least one of deleting, adding, and revising one or more of the machine-readable port mappings.

11. The apparatus of claim 10, wherein the processor is further configured to:
if the compare indicates a port mapping mismatch between the model and actual port mappings, repeat the operations to selectively enable and accept editing, collect port configurations, generate actual port mappings, compare, and the generate a compliance report.

12. The apparatus of claim 10, wherein the processor is configured to selectively enable by:
prompting a user to select whether to edit the model port mappings; and
if the user selects to edit the model port mappings, displaying an editable list of the model port mappings through which the user performs the at least one of the deleting, adding, and revising of the one of more model port mappings.

13. The apparatus of claim 9, wherein the processor is configured to generate a compliance report by displaying the mismatches, if any, between the model and actual port mappings.

14. The apparatus of claim 9, wherein:
the processor is configured to import by importing the model port mappings as a first Extensible Markup Language (XML) document;
the processor is configure to generate actual port mappings by generating the actual port mappings as a second XML document; and
the processor is configured to compare by comparing the first and second XML documents against each other.

15. A processor readable medium storing instructions that, when executed by a processor, cause the processor to:
import a machine-readable cable specification for a model converged infrastructure including model compute, storage, and network components, each of the model components including model ports to receive and send signals, the cable specification including machine-readable model port mappings that specify model connections between the model ports;
interface with an actual converged infrastructure that includes operating compute, storage, and network components and connections between ports of the components;
collect from each of the operating compute, storage, and network components respective port configurations indicative of the connections between the ports of the components;
generate actual port mappings that identify the connections between the ports of the components based on the collected port configurations;
compare the actual port mappings against the model port mappings; and
generate a compliance report indicating port mapping mismatches, if any, between the model and actual port mappings based on the comparing.

16. The processor readable medium of claim 15, further comprising instructions to cause the processor to, prior to causing the processor to compare:
selectively enable editing of the model port mappings; and
if the editing is enabled, accept editing of the machined readable model port mappings, including at least one of deleting, adding, and revising one or more of the machine-readable port mappings.

17. The processor readable medium of claim 16, further comprising instructions to cause the processor to:
if the compare indicates a port mapping mismatch between the model and actual port mappings, then repeat the operations to selectively enable and accept editing, collect port configurations, generate actual port mappings, compare, and generate a compliance report.

18. The processor readable medium of claim 17, wherein the instructions to cause the processor to selectively enable editing include instructions to cause the processor to:
prompt a user to select whether to edit the model port mappings; and
if the user selects to edit the model port mappings, display an editable list of the model port mappings through which the user performs the at least one of the deleting, adding, and revising of the one of more model port mappings.

19. The processor readable medium of claim 15, wherein the instructions to cause the processor to generate a compliance report include instructions to cause the processor to display the mismatches, if any, between the model and actual port mappings.

20. The processor readable medium of claim 15, wherein:
the instructions to cause the processor to import include instructions to cause the processor to import the model port mappings as a first Extensible Markup Language (XML) document;
the instructions to cause the processor to generate actual port mapping include instructions to cause the processor to generate the actual port mappings as a second XML document; and
the instructions to cause the processor to compare include instructions to cause the processor to compare the first and second XML documents against each other.
